(19) United States
(12) Patent Application Publication
(10) Pub. No.: US 2026/0092161 A1
(43) Pub. Date: Apr. 2, 2026

(54) CURABLE COMPOSITIONS, ARTICLES AND COATED ARTICLES FORMED THEREFROM

(71) Applicant: PPG INDUSTRIES OHIO, INC., CLEVELAND, OH (US)

(72) Inventors: CHINMING HUI, PITTSBURGH, PA (US); GUOBIN SHAN, PITTSBURGH, PA (US); PATRICIA OLIVIA TREVINO SUAREZ DEL REAL, PITTSBURGH, PA (US); DAVID SCHMIDT, BOONES MILL, VA (US); WILLIAM EARL ISHMAEL, JR., TULSA, OK (US)

(73) Assignee: PPG INDUSTRIES OHIO, INC., CLEVELAND, OH (US)

(21) Appl. No.: 19/329,662

(22) Filed: Sep. 16, 2025

Related U.S. Application Data
(60) Provisional application No. 63/700,860, filed on Sep. 30, 2024.

(51) Int. Cl. C08K 5/17; C08G 18/08; C08G 18/32; C08G 18/34; C08G 18/50; C08G 18/65; C08G 18/72; C08K 3/36

(52) U.S. Cl. CPC C08K 5/17; C08G 18/0838; C08G 18/3234; C08G 18/341; C08G 18/5024; C08G 18/6505; C08G 18/6541; C08G 18/722; C08K 3/36; C08K 2201/005; C08K 2201/006

(57) ABSTRACT

Curable compositions are provided comprising: a) an isocyanate-functional component and b) an amine-functional component comprising i) a primary amine- and/or a secondary amine-functional compound, and ii) a tertiary amine-functional compound. The tertiary amine-functional compound is present in the amine-functional component b) in an amount of 3.5 to 7 percent by weight, based on the total weight of amine-functional compounds in the amine-functional component b). Also provided are curable compositions comprising the above and c) untreated silica particles. The untreated silica particles are present in the curable composition in an amount of 0.5 to 15 percent by weight, based on the total weight of solids in the curable composition. Additionally provided are coated articles and polyurea articles formed from the curable compositions above.

### CROSS REFERENCE TO RELATED APPLICATIONS

The present application claims priority to U.S. Provisional Application No. 63/700,860, filed Sep. 30, 2024, titled “CURABLE COMPOSITIONS, ARTICLES AND COATED ARTICLES FORMED THEREFROM”, incorporated herein by reference in its entirety.

### FIELD OF THE DISCLOSURE

The present disclosure is directed to curable polyurea compositions that demonstrate low gloss.

### BACKGROUND

Polyurea is a fast-curing chemistry that typically produces an attractive, high-gloss surface. Polyurea elastomers have been among the coating compositions commercially applied to various substrates to provide protection to the substrates and to improve properties of the substrates such as protection from corrosion, abrasion, impact damage, chemicals, UV light and other environmental conditions. Polyurea compositions have been used as moldable compositions and protective coatings in industrial applications for manufacturing and coating of equipment or parts, such as vehicle components, to provide corrosion resistance or as caulks and sealants in a variety of aggressive environments.

Low-gloss surfaces may be desirable for aesthetic or other purposes; however, low-gloss polyurea is very difficult to produce. In other curable compositions, matting agents can be readily added to a formulation to lower the gloss of the cured composition. For example, in a coating composition, matting agents such as particulate waxes or inorganic compounds migrate to the surface of the coating upon application, but before curing.

Unfortunately, such an approach is not effective in a fast-curing composition such as a polyurea, because the matting agents typically do not have enough time to migrate to the surface prior to curing of the composition.

It would be desirable to provide curable polyurea compositions that demonstrate low gloss for use as coating compositions or articles of manufacture.

### SUMMARY OF THE DISCLOSURE

Curable compositions are provided comprising: a) an isocyanate-functional component and b) an amine-functional component comprising i) a primary amine- and/or a secondary amine-functional compound, and ii) a tertiary amine-functional compound. The tertiary amine-functional compound is present in the amine-functional component b) in an amount of 3.5 to 7 percent by weight, based on the total weight of amine-functional compounds in the amine-functional component b).

Also provided are curable compositions comprising the above and c) untreated silica particles. The untreated silica particles are present in the curable composition in an amount of 0.5 to 15 percent by weight, based on the total weight of solids in the curable composition.

Additionally provided are coated articles and polyurea articles formed from the curable compositions above.

### DETAILED DESCRIPTION

Other than in the operating examples, or where otherwise indicated, all numbers expressing quantities of ingredients, reaction conditions and so forth used in the specification and claims are to be understood as being modified in all instances by the term “about,” even if the term does not expressly appear. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical values, however, inherently contain certain errors necessarily resulting from the standard deviation found in their respective testing measurements.

Any numerical range recited herein is intended to include all sub-ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10.

Plural encompasses singular and vice versa; e. g., the singular forms “a,” “an,” and “the” include plural referents unless expressly and unequivocally limited to one referent. For example, where the disclosure has been described in terms of “a” primary amine-functional compound or “an” isocyanate-functional compound, a plurality, including a mixture of such compounds, can be used.

The present disclosure provides curable compositions that yield cured polyurea articles and coatings exhibiting a matte (low-gloss) finish. By “low-gloss” is meant demonstrating a 60° gloss lower than 50, or lower than 40, or lower than 25, or lower than 10.

The curable compositions of the present disclosure may be sprayable, castable, extrudable, or moldable. They may be used, for example, as adhesives, sealants, film-forming compositions, or in the manufacturing of an article. The terms “film-forming” and “coating” with respect to compositions are used interchangeably. Such compositions may be in a solid particulate form such as a powder coating composition, solventborne, or waterborne.

The curable compositions typically comprise a) an isocyanate-functional component. The isocyanate-functional component may comprise a polyisocyanate prepolymer, for example reaction products of polyisocyanates with polyols, or a blend of polyisocyanates; e.g., a blend of one or more polyisocyanate prepolymers and/or one or more monomeric polyisocyanates. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

Suitable polyisocyanates include isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H12MDI); mixed aralkyl diisocyanates such as tetramethylxylyl diisocyanates, OCN—C(CH₃)₂—C₆H₄C(CH₃)₂—NCO; and polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate. Aliphatic isocyanates are particularly useful in producing polyurea articles and coatings that are resistant to degradation by UV light. However, in other circumstances, less costly aromatic polyisocyanates may be used when durability is not of significant concern. Non-limiting examples of aromatic polyisocyanates include phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate and alkylated benzene diisocyanates generally; methylene-interrupted aromatic diisocyanates such as methylenediphenyl diisocyanate, especially the 4,4′-isomer (MDI) including alkylated analogs such as 3,3′-dimethyl-4,4′-diphenylmethane diisocyanate and polymeric methylenediphenyl diisocyanate.

An excess of polyisocyanate monomer (i. e., residual free monomer from the preparation of prepolymer) can allow for improved flow of the curable composition over the substrate. Excess polyisocyanate monomer also has been observed in some instances to provide improved adhesion of a polyurea coating to a previously applied coating and/or to the substrate itself. For example, the cured coatings that have previously been applied to automotive surfaces can comprise functional groups (e.g. hydroxyl groups) that are reactive to isocyanates, thereby enhancing adhesion of the sprayed polyurea composition to the first coating. In a particular example of the present disclosure, at least 1 percent by weight, or at least 2 percent by weight, or at least 4 percent by weight of the isocyanate-functional composition comprises at least one polyisocyanate monomer (i.e., residual free polyisocyanate monomer).

The use of various oligomeric polyisocyanates (e.g., dimers, trimers, polymeric, etc.) and modified polyisocyanates (e.g., carbodiimides, uretone-imines, etc.) is also within the scope of the disclosure.

The curable compositions further comprise b) an amine-functional component comprising a primary amine- and/or a secondary amine-functional compound. Often the amine-functional component comprises both a primary amine-functional compound and a secondary amine-functional compound. The primary and secondary amine functional groups may be present on the same molecule, different molecules, or both. The amines may be monoamines, or polyamines such as diamines, triamines, higher polyamines and/or mixtures thereof. The amines also may be aromatic or aliphatic (e.g., cycloaliphatic). In certain examples, the amine-functional component comprises aliphatic amines, believed to provide enhanced durability.

In particular examples, the amine-functional component includes at least one secondary amine-functional compound, present in an amount of 15 to 80 percent by weight, or 20 to 80 percent by weight, or 50 to 80 percent by weight, based on the total weight of amine-functional compounds in the amine-functional component b). In particular examples, the amine-functional component includes at least one primary amine-functional compound, present in an amount of 15 to 80 percent by weight, or 20 to 80 percent by weight, or 50 to 80 percent by weight, based on the total weight of amine-functional compounds in the amine-functional component b).

Examples of suitable aliphatic polyamines include, without limitation, ethylamine, the isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

The secondary amine may comprise an aliphatic amine, such as a cycloaliphatic diamine. Such amines are available commercially from Huntsman Corporation (Houston, TX) under the designation of JEFFLINK™ such as JEFFLINK™ 754. In another embodiment, the amine can be provided as an amine-functional resin. Such amine-functional resin can be a relatively low viscosity, amine-functional resin suitable for use in the formulation of high solids polyurea coatings. While any of a number of different amine-functional resins may be suitable, in certain examples of the disclosure, the amine-functional resin comprises an ester of an organic acid, for example, an aspartic ester-based amine-functional reactive resin that is compatible with isocyanates; e.g., one that is solvent-free, and/or has a mole ratio of amine-functionality to the ester of no more than 1:1 so there remains no excess primary amine upon reaction. One example of such polyaspartic esters is the derivative of diethyl maleate and 1,5-diamino-2-methylpentane, available commercially from Covestro of Pittsburgh, PA under the trade name DESMOPHEN NH1220. Other suitable compounds containing aspartate groups may be employed as well. Additionally, the secondary polyamines can include polyaspartic esters which can include derivatives of compounds such as maleic acid, fumaric acid esters, aliphatic polyamines and the like.

The amine-functional component also may include polymeric primary amines, such as polyoxyalkyleneamines. The polyoxyalkyleneamines contain two or more primary amino groups attached to a backbone, derived, for example, from propylene oxide, ethylene oxide, or a mixture thereof. Examples of such amines include those available under the designation JEFFAMINE™ from Huntsman Corporation. Such amines include, without limitation, JEFFAMINE D-230, D-400, D-2000, T-403 and T-5000.

The amine-functional component b) further comprises a tertiary amine-functional compound. Suitable tertiary amine-functional compounds include, for example, pentamethyldiethylene triamine, triethanolamine, 1,4-diazabicyclo[2.2.2]octane (DABCO), N,N,N′,N′,N″-pentamethyldiethylenetriamine (sold under the name POLYCAT 5, available from Evonik), N,N′,N″-Tris(dimethylaminopropyl) hexahydrotriazine (sold under the name DESMORAPID® by Covestro AG), and/or dimethylethanolamine.

The tertiary amine-functional compound is typically present in the amine-functional component b) in an amount of 3.5 to 7 percent by weight, based on the total weight of amine-functional compounds in the amine-functional component b). While not intending to be bound by theory, it is believed that the tertiary amine may effect reaction of isocyanates with ambient moisture to generate carbon dioxide, which reduces the surface smoothness of the final coating and decreases gloss.

In certain examples, the curable composition further comprises untreated silica particles. Thus, the present disclosure is further drawn to curable compositions comprising:
a) an isocyanate-functional component;
b) an amine-functional component comprising i) a primary amine- and/or a secondary amine-functional compound, and ii) a tertiary amine-functional compound present in the amine-functional component b) in an amount of 3.5 to 7 percent by weight, based on the total weight of amine-functional compounds in the amine-functional component b); and
c) untreated silica particles present in an amount of 0.5 to 15 percent by weight, based on the total weight of solids in the curable composition.

The untreated silica particles may comprise precipitated silica, fumed silica, and/or silica gel. The untreated silica particles typically demonstrate a surface area less than 120 m²/g, or less than 100 m²/g, or less than 90 m²/g, as determined by the Brunauer, Emmett, Teller (BET) method according to ASTM C 819-77 using nitrogen as the adsorbate. The silica particles typically demonstrate a volume average particle size (D50) of 8 to 15 microns, or 9 to 11 microns, as determined by the use of a laser diffraction particle size instrument, such as LS230 available from Beckman Coulton, capable of measuring particle diameters as small as 0.04 micron. An example of suitable silica particles includes LO-VEL 6000, available from PPG.

The untreated silica particles are typically present in the curable composition in an amount of 0.5 to 15 percent by weight, or 0.5 to 8 percent by weight, or 0.5 to 5 percent by weight, or 0.5 to 3 percent by weight, or 1 to 15 percent by weight, or 1 to 8 percent by weight, or 1 to 5 percent by weight, or 1 to 3 percent by weight, based on the total weight of solids in the curable composition. The untreated silica particles may be added to the composition neat or in a dispersion, and may be present in the isocyanate-functional component a) and/or the amine-functional component b). Typically, they are added to the amine-functional component b).

If desired, and depending on the intended application, the curable composition can comprise other optional materials well known in the art, such as plasticizers, anti-oxidants, hindered amine light stabilizers, UV light absorbers and stabilizers, surfactants, flow control agents, thixotropic agents such as bentonite clay, pigments, fillers, organic cosolvents, catalysts, adhesion promoters, fire retardants, colorants, abrasion resistant particles and other customary auxiliaries.

As used herein, the term “colorant” means any substance that imparts color and/or other opacity and/or other visual effect to the composition. The colorant can be added to the composition in any suitable form, such as discrete particles, dispersions, solutions and/or flakes. A single colorant or a mixture of two or more colorants can be used in the compositions of the present disclosure.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the compositions by grinding or simple mixing. Colorants can be incorporated by grinding into the composition by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent- and/or aqueous-based such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triaryl methane.

Example tints include, but are not limited to, pigments dispersed in water-based or water-miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemicals, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2. Nanoparticle dispersions can also be produced by crystallization, precipitation, gas phase condensation, and chemical attrition (i.e., partial dissolution). In order to minimize re-agglomeration of nanoparticles within the composition, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005/0287348 A1, filed Jun. 24, 2004, U.S. Provisional Application Ser. No. 60/482,167 filed Jun. 24, 2003, and U.S. patent application Ser. No. 11/337,062, filed Jan. 20, 2006.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. For example, special effect compositions can produce a color shift, such that the color of the coating changes when the coating is viewed at different angles. Example color effect compositions are identified in U.S. Pat. No. 6,894,086. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

A photosensitive composition and/or photochromic composition, which reversibly alters its color when exposed to one or more light sources, can be used in the compositions of the present disclosure. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. The photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

The photosensitive composition and/or photochromic composition can be associated with and/or at least partially bound to, such as by covalent bonding, a polymer and/or polymeric materials of a polymerizable component. In contrast to some compositions in which the photosensitive composition may migrate out of the coating and crystallize into the substrate, the photosensitive composition and/or photochromic composition associated with and/or at least partially bound to a polymer and/or polymerizable component have minimal migration out of the composition. Example photosensitive compositions and/or photochromic compositions and methods for making them are identified in U.S. application Ser. No. 10/892,919 filed Jul. 16, 2004.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The ratio of equivalents of isocyanate groups to primary and/or secondary amine-functional groups may be selected to control the rate of cure of the curable polyurea composition. It has been found that two-component polyurea compositions capable of being formed in to an article, or capable of being applied to a substrate to form a coating, in a 1:1 volume ratio have advantages particularly in curing when the ratio of the equivalents of isocyanate groups to amine groups (also known as the reaction index) is greater than one, such as 1.01 to 1.10:1, or 1.03 to 1.10, or 1.05 to 1.08. “Capable of being produced in a 1:1 volume ratio” or “capable of being applied to the substrate in a 1:1 volume ratio” means that the volume ratio may vary by up to 20% for each component, or up to 10% or up to 5%.

Such curable compositions may be prepared using a two-component mixing device. For example, the polyurea compositions may be prepared using a high-pressure impingement mixing device in which equal volumes of the isocyanate-functional component and the amine-functional component are impinged upon each other and immediately sprayed onto at least a portion of a substrate to produce a coating thereover. The isocyanate-functional component and the amine-functional component react to produce a polyurea composition which is cured upon application to the substrate. High-pressure impingement mixing is particularly useful in preparing coatings from polymeric systems that have very fast reaction kinetics such as in the preparation of a polyurea. Polyurea coatings are typically formulated with a stream of an isocyanate-functional component herein referred to as an “A-side” and a stream of an amine-functional component herein referred to as a “B-side”. The A-side containing the isocyanate-functional component may be at least one polyisocyanate including monomers, prepolymers, oligomers, or a blend of polyisocyanates as described above. A prepolymer is a polyisocyanate which is pre-reacted with a sufficient amount of polyamine(s) or other isocyanate reactive components (such as one or more polyols as are well known in the art) so that reactive sites on the polyisocyanate still remain in the prepolymer. Those remaining reactive sites on the polyisocyanate prepolymer are then available to react further with components in the B-side.

The volume ratio of the isocyanate-functional component to the amine-functional component in a mixing device may be any suitable volume mixing ratio capable of being applied to a substrate for example, or injected into a mold, such as at 1:1. A 1:1 volume ratio may be selected to ensure proper mixing within a standard impingement mixing device. One example of a commercially available mixing device accepted for use in the automotive industry is a GUSMER™ VR-H-3000 proportioner fitted with a GUSMER™ Model GX-7 spray gun. In that device, pressurized streams of components of the A-side and the B-side are delivered from two separate chambers of a proportioner and are impacted or impinged upon each other at high velocity to effectuate an intimate mixing of the two components to form a polyurea composition, which is coated onto the desired substrate via the spray gun. During mixing, the components are atomized and impinged on each other at high pressure. Superior control of the polyurea reaction is achieved when the forces of the component streams are balanced. The mixing forces experienced by the component streams are determined by the volume of each stream entering the mixing chamber per unit time and the pressure at which the component streams are delivered. A 1:1 volume ratio of the components per unit time serves to equalize those forces. A 1:1 volume ratio of isocyanate to amine can be particularly relevant for the automotive OEM application of sprayable polyurea truck bed-liners.

Other application/mixing devices known in the art can be used to combine the components and apply the curable compositions of the present disclosure. One suitable application device is commonly known in the industry as a “static mix tube” applicator. In such a static mix tube, the isocyanate-functional component and the amine-functional component are each stored in a separate chamber or container. As pressure is applied, each of the components is brought into a mixing tube in a 1:1 ratio by volume. Mixing of the components is effected by way of the torturous or cork screw pathway within the tube. The exit end of the tube may have atomization capability useful in spray application of the reaction mixture. Alternatively, the fluid reaction mixture can be applied to a substrate as a bead. A suitable static mix tube applicator is available from Cammda Corporation. Another design, available from V.O. Baker, is a dual cartridge syringe applicator with either a pneumatic or manual pump applicator.

When the curable composition is to be formed into an article of manufacture, after mixing the separate components, the article may be formed by casting the curable composition into a sheet and post-processing the sheet to a desired shape and form, casting the curable composition in a mold, spraying the curable composition into a mold, 3-D printing, or injection-molding the composition. When the curable composition is used as a sealant or adhesive, the curable composition may be applied to a substrate such as by extruding the composition as a bead; and when appropriate, such as after adjoining to a separate substrate as in the case of an adhesive, exposing the composition on the substrate to conditions for a time sufficient to at least partially cure the curable composition.

When used as a coating composition, after application of the curable composition to a substrate as a coating and upon curing to form a cured coating, the cured coating may demonstrate a 60° gloss lower than 50, or lower than 40, or lower than 25. When used to form a polyurea article, after injection of the curable composition into a mold and upon curing to form a polyurea article, a surface of the polyurea article may demonstrate a 60° gloss lower than 50, or lower than 40, or lower than 25.

In some instances, a desired physical property of a polyurea coating composition is surface texture. Surface texture can be created by first spraying the polyurea composition onto the substrate to produce a smooth, substantially tack-free first layer. By “substantially tack-free” is meant the condition wherein upon gently touching the surface of the layer with a loose-fitting glove, the glove tip does not stick, or otherwise adhere, to the surface as determined by the Tack-Free Method. The Tack-Free Method provides that the coating composition be sprayed in one coat onto a non-adhering plastic sheet to a thickness of 10 to 15 mil (254-381 microns). When spraying is complete, an operator, using a loose fitting, disposable vinyl glove, such as one commercially available under the trade name Ambidex Disposable Vinyl Glove by Marigold Industrial, Norcross GA, gently touches the surface of the coating. The coating may be touched more than one time by using a different fingertip. When the glove tip no longer sticks to, or must be pulled from, the surface of the layer, the layer is said to be substantially tack-free. A time beginning from the completion of spraying until when the coating is substantially tack-free is said to be the tack-free time. The tack-free time and the cure time for the polyurea composition may be controlled by balancing levels of various composition components, for example, by balancing the ratio of primary amine to secondary amines. A second or subsequent layer of the polyurea composition then can be applied to the first layer as a texturizing layer or “dust coating”. This may be accomplished, for example, by increasing the distance between the application/mixing device and the coated substrate to form discrete droplets of the polyurea composition prior to contacting the coated substrate thereby forming controlled non-uniformity in the surface of the second layer. The substantially tack-free first layer of the polyurea coating is at least partially resistant to the second polyurea layer; i.e., at least partially resistant to coalescence of the droplets of polyurea composition sprayed thereon as the second polyurea layer or dust coating, such that the droplets adhere to, but do not coalesce with, the first layer to create surface texture. Typically, the second polyurea layer exhibits more surface texture than the first polyurea layer. An overall thickness of the two polyurea layers may range from 10 to 1000 mils, or 20 to 120 mils, such as from 40 to 110 mils, or from 60 to 100 mils (1524-2540 microns) with the first layer being one half to three quarters of the total thickness (762-1905 microns) and the dust coating being one fourth to one half of the total thickness (381-1270 microns). Note further that each layer of the polyurea coating may be deposited from different compositions. In one example, the first layer is deposited from a polyurea composition comprising an aromatic amine component and an aromatic polyisocyanate component, while the second layer is deposited from a polyurea composition comprising an aliphatic amine component and an aliphatic polyisocyanate component. It should be noted that the “first” polyurea coating layer may comprise one, two, three or more layers, and the “second” polyurea coating layer may be one or more subsequent layers applied thereover. For example, in one embodiment of the present disclosure four polyurea layers may be applied, with the fourth layer being the dust coating, with each layer having a thickness ranging from 15 to 25 mil (381-635 microns).

When applied as a textured coating composition, after application of the curable composition to a substrate as a coating and upon curing to form a cured coating, the cured coating may demonstrate a 60° gloss lower than 10.

Also provided by the present disclosure are coated articles comprising a) a substrate; and b) a coating formed from any curable composition as described above, deposited on at least a portion of the substrate; as well as polyurea articles, such as molded or extruded articles, formed from any curable composition described above. The formed article may comprise, for example, a vehicle component such as a bumper or panel, a truck bedliner insert, a pipe, a building component such as a strut or a roofing shingle, a component of a marine vehicle, a component of a wind blade, and the like.

Substrates to which compositions of the present disclosure may be applied include rigid metal substrates such as ferrous metals, aluminum, aluminum alloys, copper, and other metal and alloy substrates. The ferrous metal substrates used in the practice of the present disclosure may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. The substrate may alternatively comprise a polymer or a composite material such as a carbon fiber and/or fiberglass composite. Vehicle parts/components typically formed from thermoplastic and thermoset materials include bumpers and trim.

Steel substrates (such as cold rolled steel or any of the steel substrates listed above) coated with a weldable, zinc-rich or iron phosphide-rich organic coating are also suitable for use in the present disclosure. Such weldable coating compositions are disclosed in U.S. Pat. Nos. 4,157,924 and 4,186,036. Cold rolled steel is also suitable when pretreated with an appropriate solution known in the art, such as a metal phosphate solution, an aqueous solution containing at least one Group IIIB or IVB metal, an organophosphate solution, an organophosphonate solution, and combinations thereof, as discussed below. Examples of aluminum alloys include those alloys used in the automotive or aerospace industry, such as 2000, 6000, or 7000 series aluminums; 2024, 7075, 6061 are particular examples. Alloys may be unclad or they may contain a clad layer on one or more surfaces, the clad layer consisting of a different aluminum alloy than the base/bulk alloy beneath the clad layer.

The substrate may alternatively comprise more than one metal or metal alloy in that the substrate may be a combination of two or more metal substrates assembled together such as hot-dipped galvanized steel assembled with aluminum substrates. The substrate may comprise part of a vehicle, a pipe, a building component such as a wall or roof, a tank such as a storage or treatment tank, flooring, a wind blade, a structure such as a bridge support, or marine hull, and the like. “Vehicle” is used herein in its broadest sense and includes all types of vehicles, such as but not limited to airplanes, helicopters, cars, trucks, buses, vans, golf carts, motorcycles, bicycles, railroad cars, tanks and the like. It will be appreciated that the portion of the vehicle that is coated according to the present disclosure may vary depending on why the coating is being used. For example, the coating composition may be used to form a bedliner in a truck bed.

The shape of the metal substrate can be in the form of a sheet, plate, bar, rod or any shape desired, but it is usually in the form of an automobile part, such as a body, door, fender, hood or bumper. The thickness of the substrate can vary as desired.

The curable composition may be applied directly to a metal substrate as a coating when there is no intermediate coating between the substrate and the curable composition. By this is meant that the substrate may be bare, as described below, or may be treated with one or more pretreatment compositions as described below, but the substrate is not coated with any coating compositions such as an electrodepositable composition or a primer composition prior to application of the curable film-forming composition of the present disclosure.

As noted above, the substrates to be used may be bare metal substrates. By “bare” is meant a virgin metal substrate that has not been treated with any pretreatment compositions such as conventional phosphating baths, heavy metal rinses, etc. Additionally, bare metal substrates being used in the present disclosure may be a cut edge of a substrate that is otherwise treated and/or coated over the rest of its surface. Alternatively, the substrates may undergo one or more treatment steps known in the art prior to the application of the curable film-forming composition.

The substrate may optionally be cleaned using conventional cleaning procedures and materials. These would include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products. Such cleaners are generally followed and/or preceded by a water rinse. The metal surface may also be rinsed with an aqueous acidic solution after or in place of cleaning with the alkaline cleaner. Examples of rinse solutions include mild or strong acidic cleaners such as the dilute nitric acid solutions commercially available and conventionally used in metal pretreatment processes.

At least a portion of a cleaned aluminum substrate surface may be deoxidized, mechanically or chemically. As used herein, the term “deoxidize” means removal of the oxide layer found on the surface of the substrate in order to promote uniform deposition of the pretreatment composition (described below), as well as to promote the adhesion of the pretreatment composition coating to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, MI), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating.

A metal substrate may optionally be pretreated with any suitable solution known in the art, such as a metal phosphate solution, an aqueous solution containing at least one Group IIIB or IVB metal, an organophosphate solution, an organophosphonate solution, and combinations thereof. The pretreatment solutions may be essentially free of environmentally detrimental heavy metals such as chromium and nickel. Suitable phosphate conversion coating compositions may be any of those known in the art that are free of heavy metals. Examples include zinc phosphate, which is used most often, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

The IIIB or IVB transition metals and rare earth metals referred to herein are those elements included in such groups in the CAS Periodic Table of the Elements as is shown, for example, in the Handbook of Chemistry and Physics, 63rd Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is used most often. An example of a titanium compound is fluorotitanic acid and its salts. An example of a hafnium compound is hafnium nitrate. An example of a yttrium compound is yttrium nitrate. An example of a cerium compound is cerous nitrate.

Typical compositions to be used in the pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG under the name NUPAL®.

In the aerospace industry, anodized surface treatments as well as chromium-based conversion coatings/pretreatments are often used on aluminum alloy substrates. Examples of anodized surface treatments would be chromic acid anodizing, phosphoric acid anodizing, boric acid-sulfuric acid anodizing, tartaric acid anodizing, sulfuric acid anodizing. Chromium-based conversion coatings would include hexavalent chromium types, such as Bonderite® M-CR1200 from Henkel, and trivalent chromium types, such as Bonderite® M-CR T5900 from Henkel.

The curable compositions of the present disclosure may be used alone as a protective layer or may serve as a direct gloss, unicoat, or monocoat, layer. Alternatively, the compositions of the present disclosure may be used in combination with other coating compositions as primers, basecoats, and/or topcoats.

After application of each composition to the substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 70 to 250° F. (27 to 121° C.) will be sufficient. More than one coating layer of the present composition may be applied if desired. Usually between coats, the previously applied coat is flashed; that is, exposed to ambient conditions for the desired amount of time.

The thickness of the coating may range from 5 to 1000 mils (127 to 25400 microns), usually from 10 to 300 mils (254 to 7620 microns). The coating composition may then be heated. In the curing operation, solvents are driven off and crosslinkable components of the composition are crosslinked. The heating and curing operation is sometimes carried out at a temperature in the range of from 70 to 465° F. (27 to 241° C.) but, if needed, lower or higher temperatures may be used. As noted previously, the coatings of the present disclosure may also cure without the addition of heat or a drying step. Additionally, a first coating composition may be applied and then a second applied thereto “wet-on-wet”, or at least one base coat may be applied on top of a primer before the primer is cured, followed by application of a clear coat to the base coat(s) before the base coat(s) is cured; i. e., “wet-on-wet-on-wet” or “3-wet”, and the entire multi-layer coating stack cured simultaneously in a compact process (also known as 3C1B). Alternatively, each coating composition can be cured before application of the next coating composition. The curable compositions of the present disclosure may serve to form one or more of the coating layers in a multi-layer coating stack.

Each of the characteristics and examples described above, and combinations thereof, may be said to be encompassed by the present disclosure. The present disclosure is thus drawn to the following nonlimiting aspects:

1. A curable composition comprising:
a) an isocyanate-functional component and
b) an amine-functional component comprising i) a primary amine- and/or a secondary amine-functional compound, and ii) a tertiary amine-functional compound present in the amine-functional component b) in an amount of 3.5 to 7 percent by weight, based on the total weight of amine-functional compounds in the amine-functional component b).

2. The curable composition of aspect 1, wherein the amine-functional component b) comprises the primary amine- and the secondary amine-functional compounds.

3. The curable composition of any preceding aspect, wherein the amine-functional component b) comprises 15 to 80 percent by weight of the primary amine-functional compound and 15 to 80 percent by weight of the secondary amine-functional compound, based on the total weight of amine-functional compounds in the amine-functional component b).

4. The curable composition of any preceding aspect, wherein the amine-functional component b) comprises 20 to 80 percent by weight of the primary amine-functional compound, based on the total weight of amine-functional compounds in the amine-functional component b).

5. The curable composition of any preceding aspect, wherein the amine-functional component b) comprises 50 to 80 percent by weight of the primary amine-functional compound, based on the total weight of amine-functional compounds in the amine-functional component b).

6. The curable composition of any preceding aspect, wherein the amine-functional component b) comprises 20 to 80 percent by weight of the secondary amine-functional compound, based on the total weight of amine-functional compounds in the amine-functional component b).

7. The curable composition of any preceding aspect, wherein the amine-functional component b) comprises 50 to 80 percent by weight of the secondary amine-functional compound, based on the total weight of amine-functional compounds in the amine-functional component b).

8. The curable composition of any preceding aspect, wherein the tertiary amine-functional compound pentamethyldiethylene triamine, triethanolamine, 1,4-diazabicyclo[2.2.2]octane (DABCO), N,N′,N″-Tris(dimethylaminopropyl) hexahydrotriazine, and/or dimethylethanolamine.

9. The curable composition of any preceding aspect, further comprising untreated silica particles present in an amount of 0.5 to 15 percent by weight, based on the total weight of solids in the curable composition.

10. The curable composition of aspect 9, wherein the untreated silica particles are present in an amount of 0.5 to 8 percent by weight, based on the total weight of solids in the curable composition.

11. The curable composition of aspect 9 or 10, wherein the untreated silica particles are present in an amount of 0.5 to 5 percent by weight, based on the total weight of solids in the curable composition.

12. The curable composition of any of aspects 9 to 11, wherein the untreated silica particles are present in an amount of 0.5 to 3 percent by weight, based on the total weight of solids in the curable composition.

13. The curable composition of any of aspects 9 to 12, wherein the untreated silica particles are present in an amount of 1 to 15 percent by weight, based on the total weight of solids in the curable composition.

14. The curable composition of any of aspects 9 to 13, wherein the untreated silica particles are present in an amount of 1 to 8 percent by weight, based on the total weight of solids in the curable composition.

15. The curable composition of any of aspects 9 to 14, wherein the untreated silica particles are present in an amount of 1 to 5 percent by weight, based on the total weight of solids in the curable composition.

16. The curable composition of any of aspects 9 to 15, wherein the untreated silica particles are present in an amount of 1 to 3 percent by weight, based on the total weight of solids in the curable composition.

17. The curable composition of any of aspects 9 to 16, wherein the untreated silica particles demonstrate a surface area less than 120 m²/g, as determined according to ASTM C 819-77.

18. The curable composition of any of aspects 9 to 17, wherein the untreated silica particles demonstrate a surface area less than 100 m²/g, as determined according to ASTM C 819-77.

19. The curable composition of any of aspects 9 to 18, wherein the untreated silica particles demonstrate a volume average particle size (D50) of 8 to 15 microns, as determined by the use of a laser diffraction particle size instrument.

20. The curable composition of any of aspects 9 to 19, wherein the untreated silica particles demonstrate a volume average particle size (D50) of 9 to 11 microns, as determined by the use of a laser diffraction particle size instrument.

21. The curable composition of any of aspects 9 to 20, wherein the untreated silica particles comprise precipitated silica, fumed silica and/or silica gel.

22. The curable composition of any of aspects 9 to 21, wherein the untreated silica particles comprise precipitated silica.

23. The curable composition of any preceding aspect, wherein equivalents of isocyanate groups to equivalents of amine groups are in a ratio of 1.01 to 1.10:1.0.

24. The curable composition of any preceding aspect, wherein the isocyanate-functional component a) comprises isophorone diisocyanate.

25. The curable composition of any preceding aspect, wherein after application of the curable composition to a substrate as a coating and upon curing to form a cured coating, the cured coating demonstrates a 60° gloss lower than 50.

26. The curable composition of any preceding aspect, wherein after application of the curable composition to a substrate as a coating and upon curing to form a cured coating, the cured coating demonstrates a 60° gloss lower than 40.

27. The curable composition of any preceding aspect, wherein after application of the curable composition to a substrate as a coating and upon curing to form a cured coating, the cured coating demonstrates a 60° gloss lower than 25.

28. The curable composition of any preceding aspect, wherein after application of the curable composition to a substrate as a coating and upon curing to form a cured coating, the cured coating demonstrates a 60° gloss lower than 10.

29. The curable composition of any preceding aspect, wherein after injection of the curable composition into a mold and upon curing to form a polyurea article, a surface of the polyurea article demonstrates a 60° gloss lower than 50.

30. The curable composition of any preceding aspect, wherein after injection of the curable composition into a mold and upon curing to form a polyurea article, a surface of the polyurea article demonstrates a 60° gloss lower than 40.

31. The curable composition of any preceding aspect, wherein after injection of the curable composition into a mold and upon curing to form a polyurea article, a surface of the polyurea article demonstrates a 60° gloss lower than 25.

32. A coated article, comprising:
a) a substrate; and
b) a coating formed from the curable composition of any preceding aspect, deposited on at least a portion of the substrate.

33. The coated article of aspect 32, wherein the substrate comprises a vehicle substrate.

34. The coated article of aspect 32 or 3, wherein the substrate comprises stainless steel.

35. A polyurea article formed from the curable composition of any of aspects 1 to 31.

36. The polyurea article of aspect 35, wherein the polyurea article comprises a molded article.

37. The polyurea article of aspect 35 or 36, wherein the polyurea article comprises a vehicle component.

The present disclosure will further be described by reference to the following examples. The examples are merely illustrative of the disclosure and are not intended to be limiting. Unless otherwise indicated, all parts are by weight. It is understood that the composition described in the specification is not necessarily limited to the working examples described therein. Components that are mentioned elsewhere in the specification as suitable alternative materials for use in the composition, but which are not demonstrated in the working Examples, are expected to provide results comparable to their demonstrated counterparts.

### EXAMPLES

Curable compositions in accordance with the present disclosure were prepared as follows:

Isocyanate-functional component (A-side)

| Ingredient | Parts by weight |
|---|---|
| Desmodur XP2580¹ | 30.25 |
| Desmodur N3900² | 30.26 |
| Isophorone | 16.39 |
| Diisocyanate | |
| Additive package | 23.1026 |

¹,²Aliphatic polyisocyanates based on hexamethylene diisocyanate, available from Covestro AG

Amine-functional component (B-side)

| Ingredient | Parts by weight |
|---|---|
| JEFFAMINE T5000¹ | 34.41 |
| DESMOPHEN NH 1220² | 32.04 |
| JEFFLINK 754³ | 24.97 |
| Additive package | 8.58 |

¹Primary triamine available from Huntsman Corporation
²Polyaspartic amine available from Covestro AG
³Secondary amine available from Huntsman Corporation

### Example 1

A curable composition was prepared wherein a tertiary amine, N.N,N′,N′,N″-pentamethyldiethylenetriamine (POLYCAT 5, available from Evonik), was added to the amine-functional component above in amounts of 3.5, 5, and 7 percent by weight, based on the total weight of amine-functional compounds in the amine-functional component. The Control Example was a curable composition made with the A-side and B-side components only.

The components were mixed in a 1:1 volume ratio using a manual gun (MK pneumatic dispenser MR TS408 MY8, available from medmix US Inc.), and spray applied to glass substrates to make films with an approximate dry-film thickness of 100 mils.

The gloss of the samples was measured at 60° using a RHOPOINT gloss meter, available from Rhopoint Instruments.

The coating was allowed to cure for 24 hours. A digital PTC Instrument Model 212—Type D durometer was installed onto a 5 kg deadweight stand, and the hardness was measured at 5 different regions on each film.

A surface rating was assigned to each coated substrate with respect to visible defects such as bubbles or pinholes. An arbitrary scale, ranging from 1 to 5 was established, with 5 as the highest value corresponding to a non-additive composition with non-visible surface defects and 1 being the lowest value, corresponding to big bubbles or craters present all over the surface.

TABLE 1
60° Gloss

| | 3.5% | 5% | 7% |
|---|---|---|---|
| Control | 50.9 | | |
| Example 1 | 22.9 | 25.2 | 21.7 |

TABLE 2
60-day Shore D Hardness

| | 3.5% | 5% | 7% |
|---|---|---|---|
| Control | 49 | | |
| Example 1 | 36.3 | 37.8 | 28.6 |

TABLE 3
Surface ratings

| | 3.5% | 5% | 7% |
|---|---|---|---|
| Control | 5 | | |
| Example 1 | 4 | 2 | 1 |

### Example 2

A curable composition was prepared wherein a tertiary amine, N,N,N′,N′,N″-pentamethyldiethylenetriamine (POLYCAT 5, available from Evonik), was added to the amine-functional component above in an amount of 3.5 percent by weight, based on the total weight of amine-functional compounds in the amine-functional component; and wherein an untreated silica was added to the B-side (amine-functional) component in an amount of 1 percent by weight, based on the total weight of solids in the curable composition. The untreated silica was prepared by simultaneously adding sodium silicate solution and sulfuric acid to a vessel at a temperature of 90° C. and at a pH of 9.5, following by filtration, washing, and spray drying. The composition was formed into a puck.

| | | | Hardness 24- | Surface |
|---|---|---|---|---|
| Example | | Gloss | hour | rating |
| Control | No additive | 50.9 | 49 | 5 |
| Example 1 | 3.5% tertiary | 22.9 | 36.3 | 4 |
| | amine | | | |
| Example 2 | 1% silica + 3.5% | 35.6 | 37.16 | 4 |
| | tertiary amine | | | |

### Example 3

The curable composition of Example 1 was also spray applied to ED7100 panels, available from ACT Test Panels. LLC using a GRACO E10HP machine. Isocyanate-functional and amine-functional components were charged into the A-side and B-side tanks, respectively. The machine was powered on, and each material was recycled through the hosing unit in separate tubes and preheated until a batch temperature of 135° F. was obtained. A GX-8 mechanical purge gun was installed to the hosing unit, and the spray pressure was set to 1500 psi. The gun trigger was squeezed to mix the material and spray the curable composition onto THE panels in a textured spray pattern fashion. To obtain a textured pattern, a dust coat is sprayed at 3 ft distance over the smooth coated panel. The panels were removed from the spray chamber after five minutes and placed in a cool, well-ventilated room to cure.

The final 60° gloss was 0.4 GU.

Whereas particular aspects of this disclosure have been described above for purposes of illustration, it will be evident to those skilled in the art that numerous variations of the details of the present disclosure may be made without departing from the disclosure as defined in the appended claims. It is understood, therefore, that this disclosure is not limited to the particular aspects disclosed, but it is intended to cover modifications that are within the spirit and scope of the disclosure, as defined by the appended claims.

What is claimed is:

1. A curable composition comprising:
a) an isocyanate-functional component and
b) an amine-functional component comprising i) a primary amine- and/or a secondary amine-functional compound, and ii) a tertiary amine-functional compound present in the amine-functional component b) in an amount of 3.5 to 7 percent by weight, based on the total weight of amine-functional compounds in the amine-functional component b).

2. The curable composition of claim 1, wherein the amine-functional component b) comprises the primary amine- and the secondary amine-functional compounds.

3. The curable composition of claim 1, wherein the amine-functional component b) comprises 15 to 80 percent by weight of the primary amine-functional compound and 15 to 80 percent by weight of the secondary amine-functional compound, based on the total weight of amine-functional compounds in the amine-functional component b).

4. The curable composition of claim 1, further comprising untreated silica particles present in an amount of 0.5 to 15 percent by weight, based on the total weight of solids in the curable composition.

5. The curable composition of claim 4, wherein the untreated silica particles demonstrate a surface area less than 100 m²/g, as determined according to ASTM C 819-77.

6. The curable composition of claim 4, wherein the untreated silica particles demonstrate a volume average particle size (D50) of 8 to 15 microns, or 9 to 11 microns, as determined by the use of a laser diffraction particle size instrument.

7. The curable composition of claim 1, wherein equivalents of isocyanate groups to equivalents of amine groups in the curable composition are in a ratio of 1.01 to 1.10:1.0.

8. The curable composition of claim 1, wherein the isocyanate-functional component a) comprises isophorone diisocyanate.

9. The curable composition of claim 1, wherein after application of the curable composition to a substrate as a coating and upon curing to form a cured coating, the cured coating demonstrates a 60° gloss lower than 50, or lower than 40, or lower than 25.

10. The curable composition of claim 1, wherein after application of the curable composition to a substrate as a coating and upon curing to form a cured coating, the cured coating demonstrates a 60° gloss lower than 10.

11. The curable composition of claim 1, wherein after injection of the curable composition into a mold and upon curing to form a polyurea article, a surface of the polyurea article demonstrates a 60° gloss lower than 50, or lower than 40, or lower than 25.

12. The curable composition of claim 4, wherein the untreated silica particles comprise precipitated silica, fumed silica and/or silica gel.

13. A coated article, comprising:
a) a substrate; and
b) a coating formed from the curable composition of claim 1, deposited on at least a portion of the substrate.

14. The coated article of claim 13, wherein the substrate comprises a vehicle substrate.

15. The coated article of claim 13, wherein the substrate comprises stainless steel.

16. A polyurea article formed from the curable composition of claim 1.

17. The polyurea article of claim 16, wherein the polyurea article comprises a molded article.

18. The polyurea article of claim 16, wherein the polyurea article comprises a vehicle component.
